(19) United States
(12) Patent Application Publication
(10) Pub. No.: US 2026/0283108 A1
(43) Pub. Date: Sep. 24, 2026

(54) ANIMAL NAIL CUTTING APPARATUS

(71) Applicant: STIM, LLC, Chesterfield, MO (US)

(72) Inventors: Ben Manheimer, III, Chesterfield, MO (US); Swee Beng Tan, Chesterfield, MO (US)

(73) Assignee: STIM, LLC, Chesterfield, MO (US)

(21) Appl. No.: 19/576,861

(22) Filed: Mar. 24, 2026

Related U.S. Application Data
(60) Provisional application No. 63/776,700, filed on Mar. 24, 2025.

(51) Int. Cl. A01K 13/00; A45D 29/02

(52) U.S. Cl. CPC A01K 13/00; A45D 29/02

(57) ABSTRACT

An animal nail trimming apparatus includes a fixed blade and a movable blade defining a cutting region for receiving an animal nail. A sensor board positioned proximate to the fixed blade carries a metallic sensor plate, and a main control board is electrically linked to and separated from the sensor board. A microcontroller having an analog-to-digital converter drives the sensor plate and obtains readings corresponding to charge or discharge time. When the sensor plate is exposed to air with no nail or quick present, the microcontroller stores a baseline value. During use, the microcontroller obtains additional readings, derives a count, compares the count to the baseline value, and actuates a quick-indicator LED array before completion of a cut to indicate the presence of nail material or quick tissue.

### CROSS-REFERENCE TO RELATED APPLICATIONS

This application claims priority to U.S. Provisional Application Serial No. 63/776,700, filed Mar. 24, 2025, titled ANIMAL NAIL CUTTING APPARATUS, the entire disclosure of which is incorporated by reference herein.

### BACKGROUND

This disclosure relates generally to animal grooming devices and, more particularly, to nail trimming apparatuses and related sensing systems for use in trimming animal nails.

Routine nail maintenance is essential for the health and comfort of domesticated animals such as dogs, cats, and other pets. However, animal nails consist of an outer keratinized structure surrounding an internal vascularized tissue known as the quick. Accidental cutting of the quick during grooming can result in pain, bleeding, and stress for both pets and their owners. This risk is exacerbated in animals with darker nails, where visual identification of the quick is challenging. Certain existing grooming tools may not provide precise mechanisms for distinguishing between safe-to-trim areas and sensitive quick tissues, leading to hesitancy or reluctance among pet owners to maintain adequate nail grooming.

### BRIEF SUMMARY

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In various aspects, an animal nail trimming apparatus is provided. The apparatus includes a fixed blade having an aperture sized and shaped to receive a portion of an animal nail, and a movable blade configured to slide past the fixed blade to effectuate cutting. The apparatus also includes a sensor board located proximate to the fixed blade, a metallic sensor plate on a forward edge of the sensor board, and a main control board electrically linked to the sensor board and separated from the sensor board. Additionally, the apparatus includes a quick-indicator LED array and a microcontroller on the main control board. The microcontroller includes an analog-to-digital converter (ADC) and is configured to drive the sensor plate and obtain ADC readings corresponding to charge or discharge time, rather than relying solely on an analog frequency reference. When the sensor plate is exposed to air with no nail or quick present in front of the sensor plate, the microcontroller is configured to store a baseline value based on one or more of the ADC readings. The microcontroller is further configured to obtain additional ADC readings, derive a first count from the additional ADC readings, and compare the first count to the baseline value. Moreover, the microcontroller is configured to trigger a corresponding output on the quick-indicator LED array prior to completion of a cut.

In various aspects, a method of operating an animal nail trimming apparatus is provided. The animal nail trimming apparatus includes a fixed blade, a movable blade, a sensor board located proximate to the fixed blade, a metallic sensor plate on a forward edge of the sensor board, a main control board electrically linked to the sensor board and separated from the sensor board, a microcontroller on the main control board, the microcontroller including an analog-to-digital converter (ADC), and a quick-indicator LED array. The method includes driving the sensor plate and obtaining ADC readings corresponding to charge or discharge time, rather than relying solely on an analog frequency reference. The method also includes, when the sensor plate is exposed to air with no nail or quick present in front of the sensor plate, storing a baseline value based on one or more of the ADC readings. Additionally, the method includes obtaining additional ADC readings, deriving a count from the additional ADC readings, and comparing the count to the baseline value. Furthermore, the method includes triggering a corresponding output on the quick-indicator LED array prior to completion of a cut.

A variety of additional aspects will be set forth in the detailed description that follows. These aspects can relate to individual features and to combinations of features. Advantages of these and other aspects will be apparent to those skilled in the art from the following description of the exemplary embodiments which have been shown and described by way of illustration. As will be realized, the present aspects described herein may be capable of other and various aspects, and their details are capable of modification in various respects. Accordingly, the figures and description are to be regarded as illustrative in nature and not as restrictive.

### BRIEF DESCRIPTION OF THE DRAWINGS

The Figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic side view of a nail on the paw of an animal, such as a dog or cat;

FIG. 2 is a schematic side view of a nail on the paw of an animal, depicting an overgrown nail with the blood supply extending into the nail;

FIG. 3 is a schematic side view of the nail of FIG. 2, depicting how repeated trimming causes the blood supply to recede with the shortening nail;

FIG. 4 is a schematic side view of the nail of FIG. 3 after a trimming, depicting the receding blood supply;

FIG. 5 is a schematic side view of the nail of FIG. 4 after additional trimming, depicting the receding blood supply;

FIG. 6 is a schematic side view of the nail, depicting a properly trimmed nail;

FIG. 7 is a sectional view of a nail trimming apparatus and a nail in the process of being trimmed by the nail trimming apparatus;

FIG. 8 is a perspective view of the nail trimming apparatus shown in FIG. 7;

FIG. 9 is a side view of the nail trimming apparatus shown in FIG. 7;

FIG. 10 is side sectional view of the nail trimming apparatus shown in FIG. 7, depicting the blade in the opened position;

FIG. 11 is a side sectional view of the nail trimming apparatus shown in FIG. 7, depicting the blade in the closed or cutting position;

FIG. 12 is a schematic circuit diagram for the digital circuit used to detect the presence of a blood supply in the nail;

FIG. 13 is a block diagram of a method of sensing a blood supply in the nail;

FIG. 14 is a block diagram of a method of sampling the nail;

FIG. 14A is a block diagram of another method of sampling the nail;

FIG. 15 is a block diagram of a method of timing for sampling the nail;

FIG. 16 is a block diagram of a method for triggering the LEDs based on the sensor detecting the blood supply of the nail;

FIG. 17 is a schematic view of the sensor and its arrangement adjacent the aperture of the fixed blade; and

FIG. 18 is a similar view to that of FIG. 17, depicting how the sensor is grounded to earth through the nail to furnish a detection of the presence of the blood supply.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be clear to those skilled in the art from the description. For example, a feature, structure, act, etc. described in one embodiment may also be included in other embodiments but is not necessarily included. Thus, the present technology can include a variety of combinations and/or integrations of the embodiments described herein.

In the following specification and claims, reference will be made to several terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and the claims, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, directional references, such as, “top,” “bottom,” “front,” “back,” “side,” “upward,” “downward,” and similar terms are used herein solely for convenience and should be understood only in relation to each other. For example, a component might in practice be oriented such that faces referred to herein as “top” and “bottom” are in practice sideways, angled, inverted, etc. relative to the chosen frame of reference.

In various examples, the present disclosure relates to an animal nail trimming apparatus having a capacitance-based digital sensing circuit configured to detect the proximity of the vascular quick before completion of a cut. In comparison with earlier capacitance-sensing clipper arrangements that relied on oscillatory or frequency-based analog signal behavior and were more susceptible to signal degradation arising from wiring, component count, and interference within the clipper housing, the presently disclosed architecture performs direct digital acquisition and processing of capacitance-related measurements using an analog-to-digital conversion (ADC) and/or charge-transfer technique. The technical problem addressed may therefore be understood as how to provide a compact quick-detection circuit for a nail trimmer that yields more stable and reliable sensing in the confined and electrically noisy environment of a hand-held clipper, while preserving practical manufacturability and ease of use. The disclosed arrangement achieves technical effects including improved signal integrity at the sensor region, reduced susceptibility to noise and drift, more reliable discrimination among air, keratinized nail tissue, and vascular quick tissue, and improved user feedback for positioning the cutting assembly prior to trimming.

In various embodiments, an analog-to-digital converter (ADC) associated with the microcontroller 42 is a high-precision or high-resolution ADC configured to detect minute capacitance changes at the sensor plate caused by proximity of the vascular quick. The sensor plate may be driven according to a charge-transfer routine, and weak analog signals corresponding to charge time, discharge time, transferred charge, or voltage level may be converted into digital values for processing by the microcontroller. By resolving slight changes in capacitance associated with changes in the electric field adjacent the sensor plate, the apparatus can more reliably detect proximity of blood vessels within the nail.

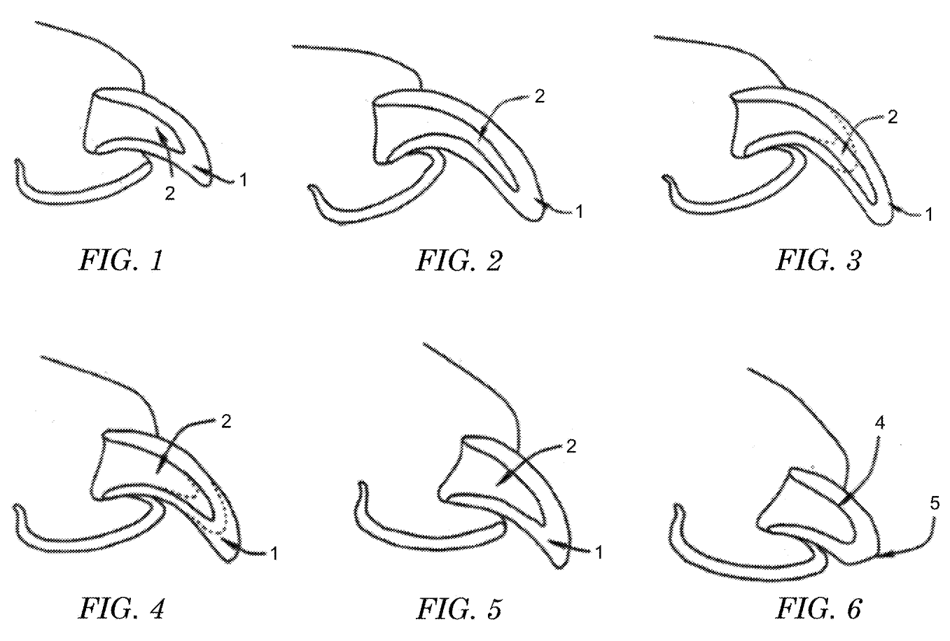

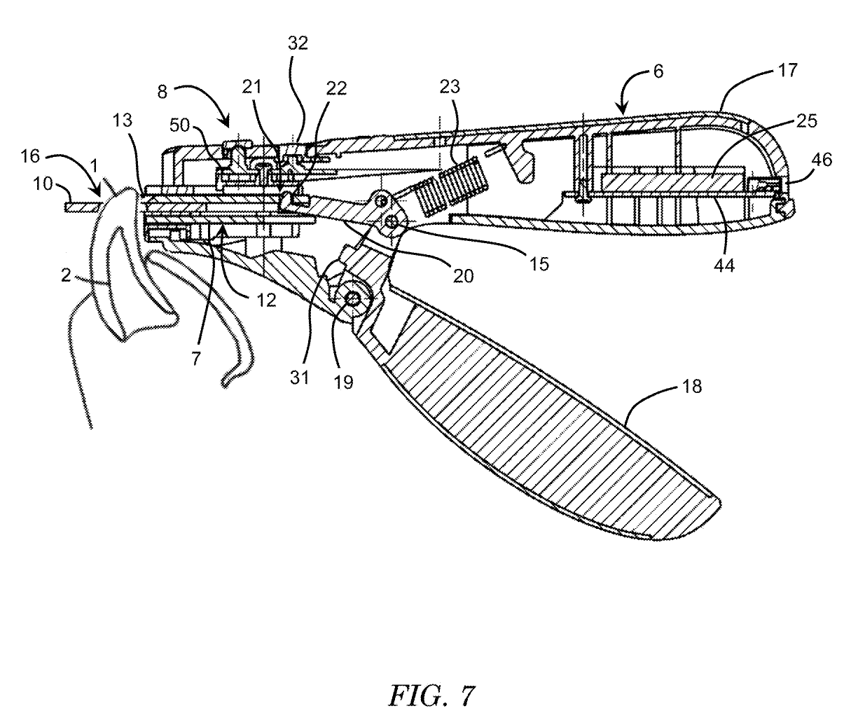

Referring to FIGS. 1–6, a pet nail 1 extends from the paw of an animal (not shown). The nail 1 consists of an outer keratinized portion, which is a dead, non-vascular structure, and an internal portion containing a blood supply 2, commonly referred to as the “quick.” Proper nail maintenance requires careful trimming to prevent injury and discomfort to the animal. The method described herein, utilizing a nail trimmer 6 (see FIG. 7) equipped with a sensor 9, allows for progressive and controlled trimming to encourage the gradual recession of the quick 2, ultimately enabling a safe and complete trim.

FIG. 1 illustrates a healthy and properly maintained nail 1, with the quick 2 contained within a short nail. In FIG. 2, an overgrown nail is depicted, showing an extended quick 2, which presents a challenge for safe trimming. If an excessive portion of the nail 1 is clipped at this stage, there is a high risk of cutting into the quick 2, resulting in pain and bleeding.

FIG. 3 demonstrates the effect of gradual trimming. When only small portions are removed at a time, the quick 2 will naturally recede over successive trimming sessions, creating a shorter nail. FIG. 4 further illustrates this recession process after a trimming session, showing the quick 2 withdrawing towards the paw.

FIG. 5 presents an additional stage of nail shortening, with the quick 2 receding further as a result of continued trimming. At this point, the nail 1 has reached a length where the dead, keratinized portion can be trimmed without encountering the quick 2. Finally, FIG. 6 illustrates a properly trimmed nail 1, where the quick 2 has sufficiently receded, allowing for safe and painless trimming.

The trimming method described is particularly advantageous for pet owners who are hesitant to cut their pet’s nails due to the risk of injury. By using an incremental approach, whereby small portions of the nail are trimmed periodically (e.g., daily or weekly), the quick naturally recedes, eventually allowing for a substantial trim without bleeding or discomfort.

As described further herein, the sensor-equipped clipper 6 aids in this process by detecting the quick 2 within the nail 1, preventing accidental injury. The sensor technology disclosed allows for precise identification of the boundary between the keratinized portion of the nail and the living tissue or quick 2. This innovation ensures that the nail 1 is trimmed only to a safe length, reducing the likelihood of pain and trauma to the animal.

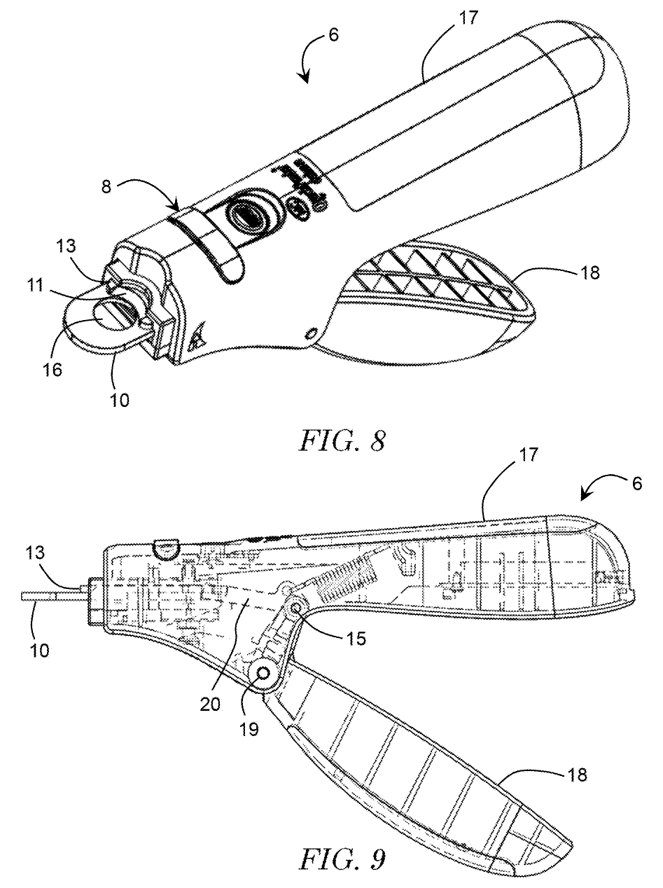

Referring now to FIGS. 7–12, a nail trimming apparatus 6 is illustrated. The nail trimming apparatus 6 is generally configured to trim an animal’s nail 1 while preventing inadvertent injury to the vascularized region of the nail, referred to herein as the quick 2. The nail trimming apparatus 6 integrates a guillotine-style mechanical cutting assembly with a capacitance-based sensing system, visual indicators, and a battery-powered control and sensing circuit 24.

The nail trimming apparatus 6 includes a fixed blade 10 and a movable blade 13. The fixed blade 10 includes an aperture 16 sized and shaped to receive a portion of the animal’s nail 1. The movable blade 13 is configured to slide past the fixed blade 10 to effectuate cutting. The movable blade 13 includes an aperture 11 that aligns with aperture 16 in the open position.

A pair of handles 17 and 18, pivotally joined by a pin 19 (see FIG. 9), control the movement of the movable blade 13. Handle 18 is connected to the movable blade 13 by way of a linkage arm 20 and pins 15 and 22, with the linkage arm 20 sliding within a slot 21 formed in movable blade 13. A spring 23 biases the handle 18 away from the handle 17, thus returning movable blade 13 to its open position after each cut.

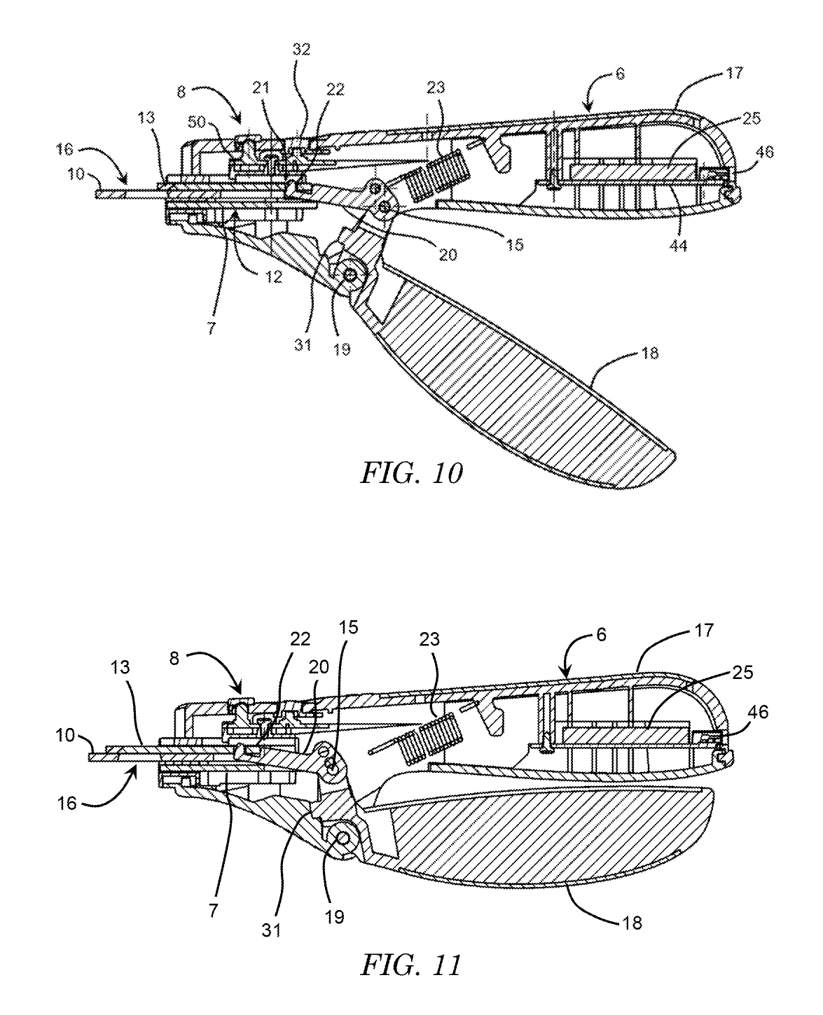

In operation, the user inserts the animal’s nail 1 through apertures 11 and 16. FIG. 10 depicts the blade 13 in this open position, leaving aperture 16 unobstructed for nail insertion. When the user squeezes the handles 17 and 18 together, the moveable blade 13 advances across the aperture 16, as shown in FIG. 11, thereby trimming the nail 1. After the user releases the handle 18, the spring 23 causes the movable blade 13 to retract to its open position. The handle 18 is prevented from contacting the handle 17 by a stopping structure 31, which engages a portion of the housing before the ends of the handles 17, 18 make contact.

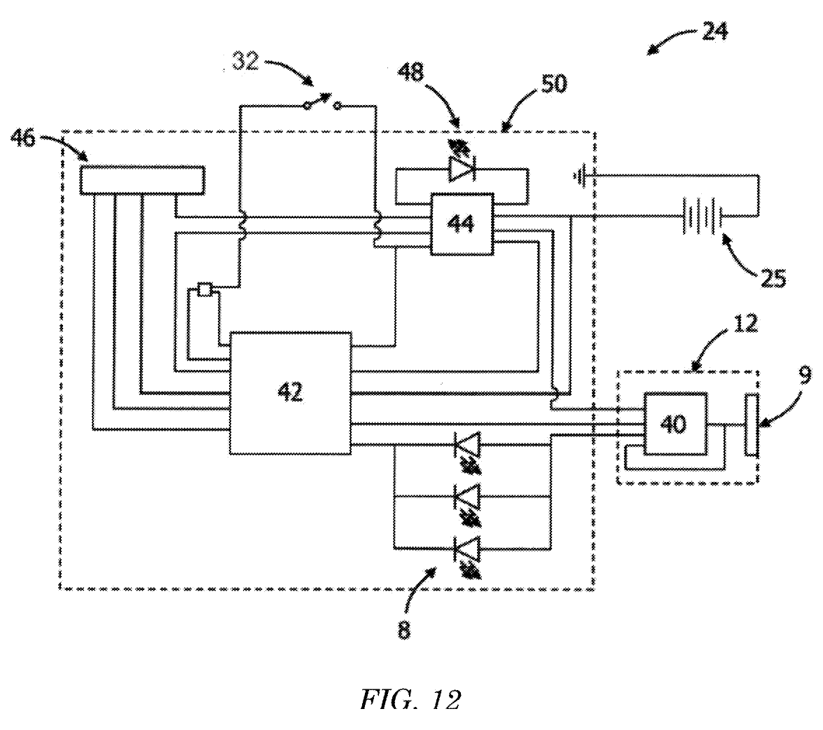

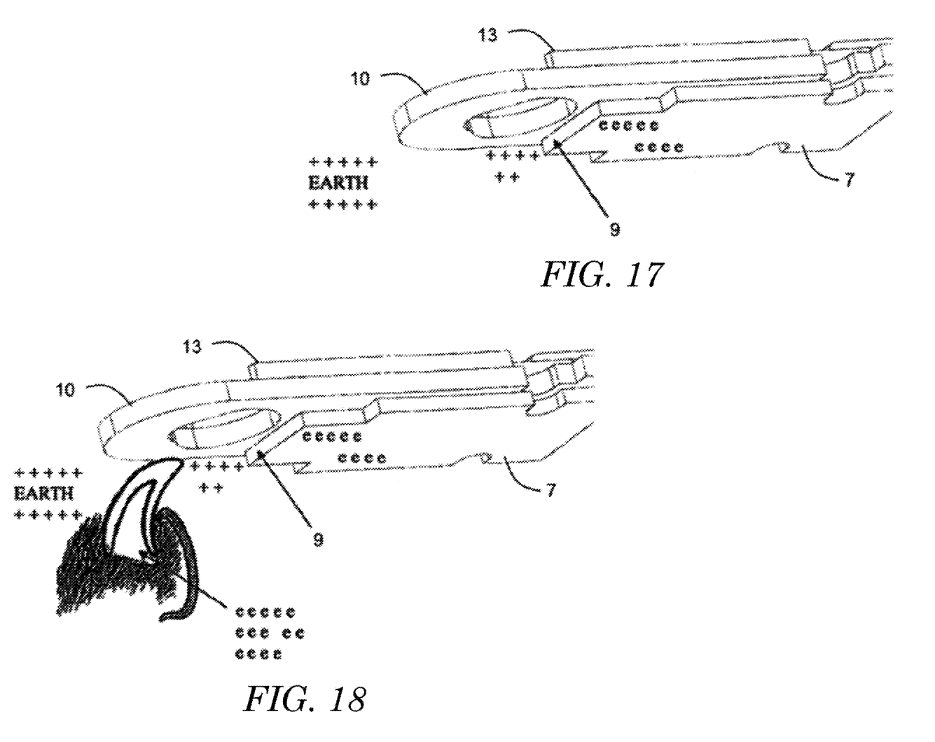

In the exemplary embodiment, the nail trimming apparatus 6 further includes a capacitance-based sensor assembly 12 that detects the presence of the quick 2 prior to cutting. A sensor board 7, including the sensor circuitry 24, is located proximate to the fixed blade 10. A metallic sensor plate 9 (see FIGS. 17 and 18) on the forward edge of sensor board 7 acts as one electrode of a capacitance sensor, with earth ground—coupled capacitively through the user or the animal—serving as the opposing electrode. The dielectric constant of any intervening material, including air, keratinized nail tissue, or vascular quick tissue, affects the sensor plate’s capacitance. When the sensor plate 9 is energized, variations in charge or discharge behavior correlate to the type of material in proximity, enabling the system to distinguish air, nail 1, and quick 2. A main control board 50 (see FIG. 12) processes and interprets these signals to provide user feedback. The microcontroller 42 (see FIG. 12) on the main control board 50 incorporates an analog-to-digital converter (ADC) or relies on external ADC circuitry, with timing managed by a timer IC 40 that regulates sampling intervals, sensor activation periods, and LED functions.

In some prior capacitance-based clipper arrangements, the sensing path relied on an oscillatory measurement architecture in which capacitance changes were inferred from frequency behavior within an analog-oriented circuit. In compact hand-held implementations, however, the routing of conductors between the sensor region and other circuit portions, the presence of multiple interconnected circuit boards, and the use of numerous active and passive components can introduce parasitic capacitance, electromagnetic interference, and other noise sources that degrade the sensing signal before interpretation. In one or more embodiments of the present disclosure, the circuit architecture is configured to reduce or mitigate such sources of signal corruption by digitally acquiring capacitance-related measurements at the sensor path and by processing those measurements in the microcontroller 42, thereby permitting cleaner signal representation, more stable classification thresholds, and improved robustness in distinguishing air, nail 1, and quick 2.

Power to the sensor circuitry 24 is supplied only when necessary. In various examples, the nail trimming apparatus 6 includes a user-actuatable power switch 32 positioned on the first handle 17, such as on an upper or top portion of the first handle 17. When the user wishes to trim a pet’s nail, the user actuates the power switch 32, thereby energizing the sensor circuitry 24 and initiating real-time detection of the material within apertures 11 and 16. In this manner, electrical activation of the sensing system is independent of movement of the handles 17 and 18 and independent of movement of the linkage arm 20. The system executes a self-calibration procedure at startup, typically by obtaining one or more ADC readings while the sensor plate 9 is exposed to air with no nail 1 or quick 2 present in front of the sensor plate 9 and storing a baseline value based on the one or more ADC readings. The microcontroller 42 then obtains additional ADC readings and compares a count derived from the additional ADC readings to the baseline value, thereby identifying changes consistent with the presence of keratinized nail material or the vascular quick 2, as described herein.

A quick-indicator LED array 8 provides the user with immediate feedback regarding the presence of the quick 2. In one or more embodiments, the array includes three light-emitting diodes: a green LED for a safe-to-cut condition, a yellow LED for a transition zone near the quick 2, and a red LED for a detected quick 2. In another embodiment, only green and red LEDs are present, where green still signals a safe-to-cut reading and red signals caution or the presence of the quick 2.

The nail trimming apparatus 6 also employs a rechargeable lithium-ion battery 25, protected and managed by a battery management IC 44 that regulates charge current, monitors battery state, and provides fault protection features, such as overvoltage and overcurrent safeguards. The battery 25 is recharged through a power connector 46, which in a preferred embodiment is a USB Type-C connector or interface, allowing universal compatibility and easy cable interfacing. In various embodiments, the power connector 46 is configured to receive a nominal five volt (5V) charging input through the USB Type-C connector, thereby enabling compatibility with common downstream power sources used for electronic devices, including smartphone charging adapters, portable power banks, and USB charging ports. A charging indicator LED 48, which may also be a multi-color LED, displays a charge status of the battery 25; red may indicate a low charge (for example, below 20%), yellow may represent a partial charge (for example, 20–90%), and green may show a full charge (for example, 90% or higher). In certain embodiments, the green and red thresholds for this charging indicator can be user-selectable or firmware-controlled to accommodate different battery chemistries and operational requirements.

In various embodiments, the battery management IC 44 is configured to perform one or more charging and power-management functions, including charge wake-up, low-voltage detection, low-voltage alarm generation, and low-voltage protective shutdown. The battery management IC 44 may further cooperate with the microcontroller 42 to place the apparatus in a reduced-power state after inactivity and to resume operation upon user actuation of switch 32 or connection of an external charging source.

In various examples, the nail trimming apparatus 6 further includes a low-voltage detector (LVD) coupled to the battery 25, for example, as part of the battery management IC 44. The LVD may be provided as a circuit separate from the microcontroller 42 and may monitor battery voltage with low quiescent power consumption while providing a highly accurate low-voltage indication. The output of the LVD may be used for warning generation, protective shutdown, charging-state control, or qualification of calibration samples.

The nail trimming apparatus 6 may further incorporate an auto-shutoff feature that switches off power after a specified period of inactivity, typically around five minutes, to conserve energy. In one or more embodiments, the physical and electrical separation of the sensor board 7 from the main control board 50 provides a layout in which the high-sensitivity sensing or detection region is isolated from power-management and logic circuitry that might otherwise inject noise into the measurement path. By reducing the effects of conductor length, parasitic coupling, component-generated interference, and other disturbances within the housing, this architecture improves the fidelity of the capacitance measurements obtained from sensor plate 9. The improved signal integrity enhances the ability of the apparatus to distinguish among air, keratinized nail tissue, and quick tissue and, in some embodiments, increases the effective sensing or detecting range so that the quick 2 can be discerned through up to approximately two to three millimeters of nail material, subject to nail thickness and composition.

The blade movement depicted in FIGS. 10 and 11 ensures that the user can precisely position the nail 1 and receive corresponding feedback from the sensor circuitry 24 prior to completing a cut, thus reducing the likelihood of cutting into the quick 2. Overall, the disclosed nail trimming apparatus 6 merges a mechanically reliable guillotine-style blade arrangement with an advanced electronic detection scheme, offering improved safety, performance, and convenience over conventional analog or unsensed grooming devices. The integrated combination of the sensor board 7, the main control board 50, and the battery management circuitry (including battery management IC 44 and power connector 46) furthers ease of use by simplifying recharging, prolonging operational time, and clarifying quick detection with minimal user input.

Referring to FIG. 12, a schematic view of the circuit 24 is depicted. The circuit 24 manages the detection of sensitive nail regions to prevent excessively close trimming. In the example embodiment, the sensor board 7 is electrically linked to the main control board 50, enabling real-time monitoring of capacitance changes in the sensor plate 9. The capacitance variations indicate whether the nail 1 contains primarily keratinized tissue or includes the vascular quick 2. When potentially unsafe readings arise, the circuit 24 triggers a corresponding output on one or more LEDs 8, signaling that the blade is positioned too near the quick 2. The LEDs 8 may illuminate in sequence, vary in color, or both, depending on the firmware programming within circuit 24. Alternatively, an audible or haptic output device may be employed in place of or alongside the LEDs, thereby offering a sensory warning to the user without requiring visual confirmation.

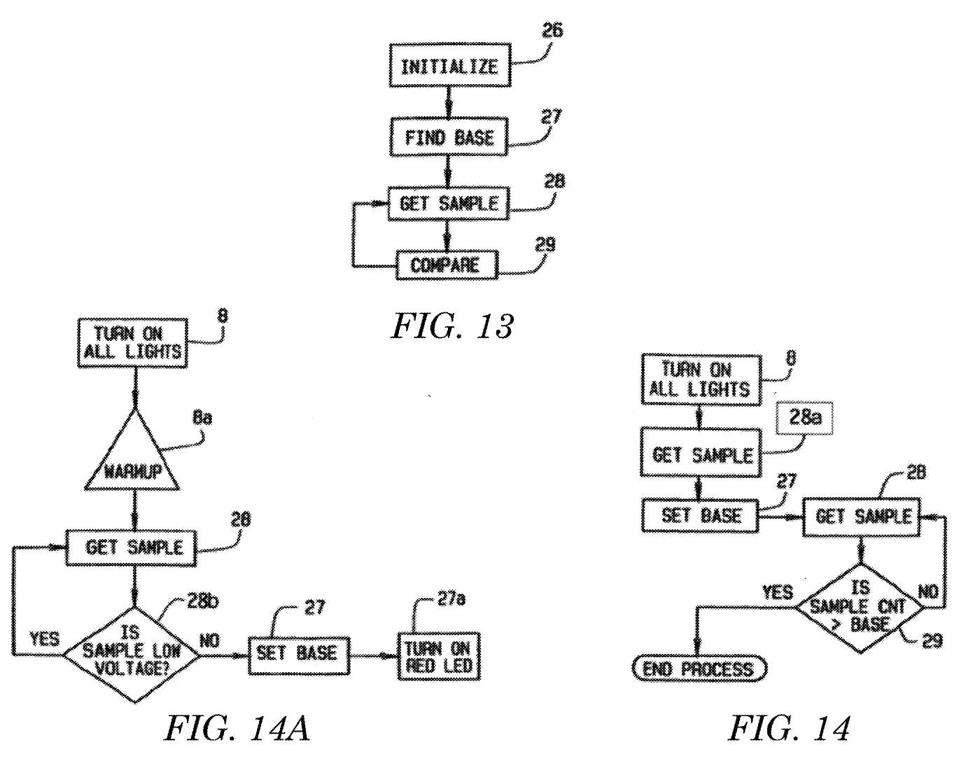

Referring to FIG. 13, a block diagram depicts the master subroutines of the software executing on a microcontroller 42 for operating the sensor circuitry 24 of the nail trimming apparatus 6. At operation 26, the user actuates switch 32 to initialize the system and supply power to the microcontroller 42, the sensor board 7, and the main control board 50. For example, the user presses the switch 32 to energize both the sensor board 7 and the main control board 50. During initialization, the microcontroller 42 sets internal variables such as a counting routine to zero and a looping routine to a certain number. It may also activate the battery management IC 44 and confirm sufficient voltage is available from the battery 25.

As used herein, an “ADC reading” refers to an individual digitally acquired reading corresponding to charge-transfer behavior, charge time, discharge time, voltage level, or a related capacitance-dependent characteristic of the sensor plate 9. A “count” refers to a value derived from one or more ADC readings, such as an elapsed time or aggregate sample value. A “baseline value” refers to a stored reference value corresponding to the condition in which the sensor plate 9 is exposed to air without a nail 1 or quick 2 present in front of the sensor plate 9. Unless the context requires otherwise, references herein to measurements or samples may correspond to ADC readings or values derived therefrom.

At operation 27, the software determines a baseline value of the sensor used for later comparison at operation 29. The program drives the sensor plate 9 on the sensor board 7 and obtains ADC readings corresponding to the charge or discharge time using the ADC, rather than relying solely on an analog frequency reference. When no nail 1 or quick 2 is present in front of the sensor plate 9, the measured time or voltage level associated with air is recorded as the baseline value. After the baseline value is initially determined, the program confirms that the sensor plate 9 was not inadvertently initialized on the nail 1 or quick 2 by obtaining additional ADC readings and comparing a count derived from the additional ADC readings to the baseline value. Once validated, the software stores the baseline value for future use.

Continuing to FIG. 14, the block diagram elaborates upon the logic used to establish this baseline value. The microcontroller 42, in conjunction with timer IC 40, activates any LEDs 8. The sensing routine checks an initial ADC reading associated with air, at 28a, to determine a stable baseline value, which is set at operation 27. The microcontroller 42 then loops, obtaining additional ADC readings 28 and comparing a count derived from the additional ADC readings to the baseline value at 29, searching for a count greater than the baseline value to ensure the sensor plate 9 did not initialize against an actual nail portion. When such a greater count is detected, the baseline value is confirmed and stored; this completes the second subroutine. During this time, the main control board 50 may illuminate specific LEDs or remain in a ready state, depending on the software’s design.

As depicted in FIG. 14A, the circuitry 24 may further refine the baseline by ensuring a low-voltage condition is met before finalizing the baseline. Samples 28 that register below an internal threshold (step (28b)) are discarded, and new samples 28 are taken until a sufficiently stable baseline emerges. Once the baseline is set at operation 27, the software may briefly illuminate a particular LED (for instance, a red LED) to indicate successful baseline calibration at step 27a.

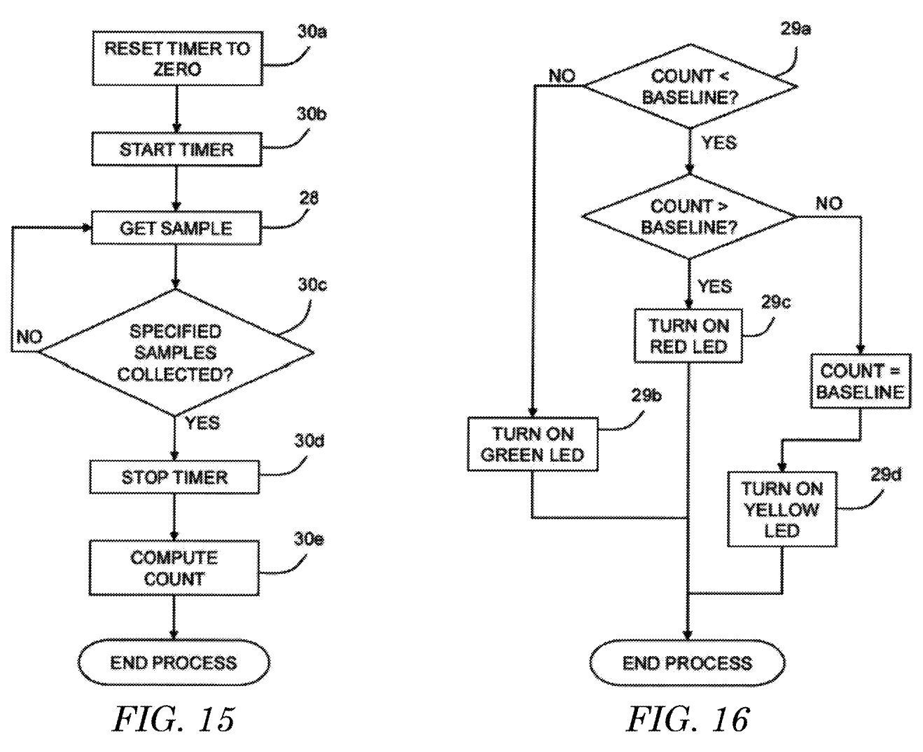

Referring to FIG. 15, the software transitions from baseline calibration into an active sampling subroutine. At step 30a, the program first sets the timer to zero, then starts the timer at step 30b. While the timer is running, the microcontroller 42, in cooperation with timer IC 40, performs repeated measurements of the charge-transfer or ADC readings from the capacitor formed by sensor plate 9, as indicated at step 28. In step 30c, the software checks whether a specified number of measurements has been collected. If not, it continues acquiring data; if so, it proceeds to step 30d to stop the timer. At step 30e, the microcontroller 42 derives a final count (elapsed time or aggregate sample value) representing the dielectric properties of the nail region. This count is then returned to the main control logic for subsequent comparison with the baseline.

Turning to FIG. 16, the final subroutine compares the newly measured count to the previously established baseline (see FIG. 13). At step 29a, the microcontroller 42 compares the count to the baseline. If the count is less than the baseline, as determined at step 29b, the green LED is illuminated to indicate only nail material is present. If the count exceeds the baseline, step 29c, the software illuminates a red LED or otherwise signals that the quick 2 is present. If the count equals the baseline, step 29d, it may illuminate or blink a yellow LED to warn of a transition zone near the quick. In an alternate embodiment containing only two LEDs, the system would simply omit the yellow LED step. After setting the appropriate LED, the circuit 24 either returns to the main loop or initiates another sampling cycle at step 30a of FIG. 15, thereby maintaining continuous or periodic monitoring of the nail’s condition. Additionally, whenever power to the microcontroller 42 is lost or interrupted, the microcontroller resets itself upon reactivation. As the system restarts from step 26 of FIG. 13, it reinitializes the baseline and sampling processes, safeguarding against improper calibrations or unexpected interruptions, and consistently maintaining reliable measurements of the nail’s dielectric characteristics.

Referring to FIGS. 7, 17 and 18, the forwardmost edge of the sensor board 7, i.e., the sensor plate 9, forms one electrode of the capacitance sensor. The sensor plate 9 may be integral with the sensor board 7, which is positioned below or adjacent the fixed blade 10. When no nail 1 is present, this electrode charges fully in a time governed by air as the dielectric. That measured charge time establishes the baseline at operation 27. FIGS. 17 and 18 show different views of the blade arrangement and sensor board 7 at the point where the nail 1 or the quick 2 affects the capacitor’s charge transfer. Because the quick 2 is conductive and has a higher dielectric constant, the microcontroller 42 infers its presence by detecting a reduced charge time, altered voltage characteristic, or other digitally acquired capacitance-related measurement relative to baseline. This direct measurement approach underlies the digital architecture’s advantage over purely analog frequency methods because the measured signal can be filtered, averaged, thresholded, and otherwise processed in firmware before a user indication is generated. As a result, the apparatus can provide more repeatable quick detection, more reliable color-state indication, and improved sensing performance, including in some embodiments detection through a greater thickness of nail material than was practically achievable with earlier oscillatory arrangements.

In various embodiments, the microcontroller 42 executes an environment-adaptive algorithm configured to update the baseline value and/or one or more detection thresholds over time to compensate for gradual changes in operating conditions, including temperature, humidity, parasitic loading, and electromagnetic conditions surrounding the sensor plate 9. The algorithm may employ filtered baseline updates, rolling averages, hysteresis, offset compensation, or drift-compensation logic so that gradual environmental changes do not cause false quick indications, while changes caused by proximity of the nail 1 or quick 2 remain detectable.

The disclosed nail trimming apparatus presents marked improvements compared to prior analog circuit designs by utilizing a capacitance-based digital sensor circuit for detecting the quick within an animal’s nail. In particular, by employing direct digital acquisition of capacitance-related measurements, rather than relying on interpretation of an oscillatory analog frequency response alone, the disclosed architecture provides greater measurement stability, reduced susceptibility to drift and interference, and improved consistency in the user-facing quick indication. In practical use, these effects translate into increased sensing distance, stronger and cleaner discrimination between safe-to-cut and caution conditions, and more dependable activation of the green, yellow, and/or red indicators as the blade approaches the quick. Through these improvements, pet owners can more confidently perform nail trimming with reduced risk of accidental cuts, thereby reducing animal pain and stress during the grooming process.

### ADDITIONAL CONSIDERATIONS

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent application, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the computer hardware components described may be regarded as being communicatively coupled. Where multiple such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the disclosure has been described with reference to the embodiments illustrated in the attached figures, it is noted that equivalents may be employed, and substitutions made herein, without departing from the scope of the disclosure as recited in the claims.

1. An animal nail trimming apparatus comprising:
a fixed blade including an aperture sized and shaped to receive a portion of an animal nail;
a movable blade configured to slide past the fixed blade to effectuate cutting;
a sensor board located proximate to the fixed blade;
a metallic sensor plate on a forward edge of the sensor board;
a main control board electrically linked to the sensor board and separated from the sensor board;
a quick-indicator LED array; and
a microcontroller on the main control board, the microcontroller including an analog-to-digital converter (ADC),
the microcontroller configured to:
drive the sensor plate;
obtain ADC readings corresponding to charge or discharge time, rather than relying solely on an analog frequency reference;
when the sensor plate is exposed to air with no nail or quick present in front of the sensor plate, store a baseline value based on one or more of the ADC readings;
obtain additional ADC readings;
derive a first count from the additional ADC readings;
compare the first count to the baseline value; and
trigger a corresponding output on the quick-indicator LED array prior to completion of a cut.

2. The animal nail trimming apparatus of claim 1,
the sensor board being separated from the main control board, the separation of the sensor board from the main control board mitigating electromagnetic interference by isolating a high-sensitivity detection region from main power and logic elements.

3. The animal nail trimming apparatus of claim 1,
the sensor board being separate from the main control board, the separation of the sensor board from the main control board enhancing detection range, enabling the apparatus to discern the quick through approximately two millimeters of nail material.

4. The animal nail trimming apparatus of claim 1, further comprising:
first and second handles configured to move the movable blade;
a linkage arm coupling the second handle to the movable blade; and
a user-actuatable switch positioned on the first handle,
actuation of the switch energizing the main board and sensor board, initiating real-time detection of material within the aperture.

5. The animal nail trimming apparatus of claim 4,
the switch being positioned on a top of the first handle.

6. The animal nail trimming apparatus of claim 1,
the step of storing the baseline value being performed as part of a self-calibration procedure executed at startup.

7. The animal nail trimming apparatus of claim 6,
the self-calibration procedure comprising:
obtaining second additional ADC readings,
deriving a second count from the second additional ADC readings,
comparing the second count to the baseline value, and
confirming the baseline value when the second count is greater than the baseline value.

8. The animal nail trimming apparatus of claim 6,
the microcontroller configured to:
refine the baseline value by determining whether an ADC reading satisfies a low-voltage condition before finalizing the baseline value,
discarding an ADC reading that does not satisfy the low-voltage condition, and
obtaining another ADC reading until a sufficiently stable baseline value emerges.

9. The animal nail trimming apparatus of claim 1,
the microcontroller configured to:
perform repeated measurements of ADC readings from a capacitor formed by the sensor plate, and
derive a final count comprising an elapsed time or aggregate sample value representing dielectric properties of a nail region.

10. The animal nail trimming apparatus of claim 9,
the microcontroller configured to:
compare the final count to the baseline value,
illuminate a green LED when the final count is less than the baseline value,
illuminate a red LED when the final count exceeds the baseline value, and
illuminate or blink a yellow LED when the final count equals the baseline value.

11. The animal nail trimming apparatus of claim 1,
the quick-indicator LED array including a green LED for a safe-to-cut condition, a yellow LED for a transition zone near the quick, and a red LED for a detected quick.

12. The animal nail trimming apparatus of claim 1, further comprising:
a rechargeable lithium-ion battery protected and managed by a battery management integrated circuit.

13. The animal nail trimming apparatus of claim 12, further comprising:
a power connector comprising a USB Type-C connector and a charging indicator LED configured to display a charge status of the battery.

14. A method of operating an animal nail trimming apparatus including a fixed blade with an aperture, a movable blade, a sensor board located proximate to the fixed blade, a metallic sensor plate on a forward edge of the sensor board, a main control board electrically linked to the sensor board and separated from the sensor board, a microcontroller on the main control board, the microcontroller including an analog-to-digital converter (ADC), and a quick-indicator LED array, the method comprising:
driving the sensor plate;
obtaining ADC readings corresponding to charge or discharge time, rather than relying solely on an analog frequency reference;
when the sensor plate is exposed to air with no nail or quick present in front of the sensor plate, storing a baseline value based on one or more of the ADC readings;
obtaining additional ADC readings;
deriving a first count from the additional ADC readings;
comparing the first count to the baseline value; and
triggering a corresponding output on the quick-indicator LED array prior to completion of a cut.

15. The method of claim 14, further comprising:
actuating, by a user, a switch positioned on a first handle of the animal nail trimming apparatus, thereby energizing sensor circuitry and initiating real-time detection of material within the aperture.

16. The method of claim 14,
the step of storing the baseline value being performed as part of a self-calibration procedure executed at startup.

17. The method of claim 16, comprising, as part of the self-calibration procedure:
obtaining second additional ADC readings,
deriving a second count from the second additional ADC readings,
comparing the second count to the baseline value, and
confirming the baseline value when the second count is greater than the baseline value.

18. The method of claim 16, comprising:
refining the baseline value by determining whether an ADC reading satisfies a low-voltage condition before finalizing the baseline value,
discarding an ADC reading that does not satisfy the low-voltage condition, and
obtaining another ADC reading until a sufficiently stable baseline value emerges.

19. The method of claim 14, comprising:
performing repeated measurements of ADC readings from a capacitor formed by the sensor plate, and
deriving a final count comprising an elapsed time or aggregate sample value representing dielectric properties of a nail region.

20. The method of claim 19, comprising:
comparing the final count to the baseline value,
illuminating a green LED when the final count is less than the baseline value,
illuminating a red LED when the final count exceeds the baseline value, and
illuminating or blinking a yellow LED when the final count equals the baseline value.
